(19) United States
(12) Patent Application Publication
(10) Pub. No.: US 2026/0292889 A1
(43) Pub. Date: Sep. 24, 2026

(54) METHOD AND SYSTEM FOR ALLOCATING FRONTHAUL NETWORK RESOURCES BASED ON RANDOM ACCESS CHANNEL (RACH) REQUESTS

(71) Applicant: TELEFONAKTIEBOLAGET LM ERICSSON (PUBL), Stockholm (SE)

(72) Inventors: Igor Almeida, INDAIATUBA-SP (BR); Eduardo Lins de Medeiros, SUNDBYBERG (SE); Per-Erik Eriksson, STOCKHOLM (SE); Gyanesh Patra, JÄRFÄLLA (SE)

(21) Appl. No.: 19/472,979

(22) PCT Filed: Apr. 6, 2023
(86) PCT No.: PCT/IB2023/053543

§ 371 Date: Oct. 6, 2025

(51) Int. Cl. H04W 74/0833; H04W 76/28

(52) U.S. Cl. CPC H04W 74/0833; H04W 76/28

(57) ABSTRACT

Embodiments include methods, electronic device, storage medium, and computer program for allocating resources in a fronthaul network. In one embodiment, a method comprises determining that a number of Random Access Channel (RACH) requests received at a first radio frequency (RF) node for a first cell from a plurality of UEs during a time period has reached a threshold, where the first cell is included in a plurality of cells served by a fronthaul network, and where a first set of resources is dedicated to the first cell. The method further comprises, in response to determining that the number of RACH requests received during the time period reached the threshold, triggering a resource reconfiguration of the fronthaul network to allow a second set of resources dedicated to a second cell to be used to serve the first cell, in addition to the first set of resources.

### TECHNICAL FIELD

Embodiments of the present disclosure relate to the field of networking and more specifically, to allocating fronthaul network resources based on random access channel (RACH) requests.

### BACKGROUND ART

In a Fifth Generation (5G) Radio Access Network (RAN) (e.g., one defined in the Third Generation Partnership Project (3GPP)), a radio frequency (RF) node and a baseband node may either be deployed together at the radio site, or the baseband node may be centralized at a baseband hotel for better utilization. The first deployment option is called distributed radio access network (DRAN) with point-to-point links, each between a RF node and a baseband node, whereas the latter is called centralized radio access network (CRAN) or main remote deployment, with shared links between a set of RF nodes and a set of baseband nodes. In either deployment, these connections between the RF and baseband nodes form a fronthaul (FH) network.

The fronthaul network may be packet-based, carrying time-sensitive physical layer data (e.g., Long Term Evolution (LTE) or New Radio (NR) data). The deployment of CRAN and shared links has gained more popularity. Yet in CRAN, with fronthaul links shared between multiple RAN units, the fronthaul link utilization fluctuates with the number of user equipment (UEs) being served. If the traffic sources (e.g., either RF or baseband nodes) are uncoordinated and the network is not dimensioned for simultaneous peak rates, the network might experience unacceptable queueing or packet losses that have detrimental effect over radio performance.

Conversely, if the fronthaul network is over dimensioned, capital expenditure (CAPEX) may be too high due to the cost of optical transceivers, electrical/optical switching equipment, and fiber (e.g., cost of ports, trenching). Additionally, due to demand fluctuation, over dimensioning might also contribute to higher operating expenditure (OPEX) when the extra links will be underutilized (power costs, dark fiber rental cost).

Therefore, it is desirable to dimension a fronthaul network such that the peak rates over the air are not severely limited, but the bandwidth and other resources in the fronthaul network still are reasonably utilized throughout daily operation. However, UE Random Access Channel (RACH) request surges can occur due to events such as network anomalies and/or maintenance activities, when the fronthaul network is dimensioned under the assumption of normal operation. During a RACH request surge, the peak rates may exceed the peak rates for which the fronthaul network is dimensioned, even though some fronthaul network resources are available to be configured to process these RACH requests and subsequent operations following these RACH requests. As a result, the RACH request surge leads to suboptimal radio performance in the fronthaul network.

### SUMMARY OF THE INVENTION

Embodiments include methods, electronic device, storage medium, and computer program for allocating fronthaul network resources in a fronthaul network. In one embodiment, a method comprises determining that a number of Random Access Channel (RACH) requests received at a first radio frequency (RF) node for a first cell from a plurality of user equipments (UEs) during a time period has reached a threshold, where the first cell is included in a plurality of cells served by a fronthaul network, and where a first set of resources in the fronthaul network is dedicated to the first cell. The method further comprises, in response to determining that the number of RACH requests received during the time period reached the threshold, triggering a resource reconfiguration of the fronthaul network to allow a second set of resources dedicated to a second cell included in the plurality of cells to be used to serve the first cell, in addition to the first set of resources.

In one embodiment, an electronic device comprises a processor and machine-readable storage medium that provides instructions that, when executed by the processor, are capable of causing the processor to perform the operation of determining that a number of Random Access Channel (RACH) requests received at a first radio frequency (RF) node for a first cell from a plurality of user equipments (UEs) during a time period has reached a threshold, where the first cell is included in a plurality of cells served by a fronthaul network, and where a first set of resources in the fronthaul network is dedicated to the first cell. The processor is caused to further perform, in response to determining that the number of RACH requests received during the time period reached the threshold, triggering a resource reconfiguration of the fronthaul network to allow a second set of resources dedicated to a second cell included in the plurality of cells to be used to serve the first cell, in addition to the first set of resources.

In one embodiment, a machine-readable storage medium that provides instructions that, when executed by a processor, are capable of causing the processor to perform the operation of determining that a number of Random Access Channel (RACH) requests received at a first radio frequency (RF) node for a first cell from a plurality of user equipments (UEs) during a time period has reached a threshold, where the first cell is included in a plurality of cells served by a fronthaul network, and where a first set of resources in the fronthaul network is dedicated to the first cell. The processor is caused to further perform, in response to determining that the number of RACH requests received during the time period reached the threshold, triggering a resource reconfiguration of the fronthaul network to allow a second set of resources dedicated to a second cell included in the plurality of cells to be used to serve the first cell, in addition to the first set of resources.

Through embodiments of the invention, the resource reconfiguration shifts away fronthaul network resources that were dedicated to a cell that is experiencing service outage to address the RACH signal storm and accompanying shift in demand caused by the cell service outage. The reconfiguration thus enhances the performance of UEs leaving the cell with service outage and increases overall resource usage efficiency of the fronthaul network.

### BRIEF DESCRIPTION OF THE DRAWINGS

The invention may best be understood by referring to the following description and accompanying drawings that are used to illustrate embodiments of the invention. In the drawings:

FIGS. 1A-1B illustrate fronthaul network resource reallocation upon a cell service outage per some embodiments.

FIG. 2 illustrates fronthaul network operations when user equipments (UEs) join a neighbor cell.

FIG. 3 illustrates fronthaul network resource reconfiguration through a first set of embodiments.

FIG. 4 illustrates fronthaul network resource reconfiguration through a second set of embodiments.

FIG. 5 is a flow diagram illustrating the operations of allocating fronthaul network resources based on random access channel (RACH) requests per some embodiments.

FIG. 6 illustrates an electronic device implementing adaptive fault remediation per some embodiments.

FIG. 7 illustrates an example of a communication system per some embodiments.

FIG. 8 illustrates a user equipment (UE) per some embodiments.

FIG. 9 illustrates a network node per some embodiments.

FIG. 10 is a block diagram of a host, which may be an embodiment of the host of FIG. 7, per various aspects described herein.

FIG. 11 is a block diagram illustrating a virtualization environment in which functions implemented by some embodiments may be virtualized.

FIG. 12 illustrates a communication diagram of a host communicating via a network node with a user equipment (UE) over a partially wireless connection per some embodiments.

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

### Resource Configuration of Fronthaul Network

In a centralized Radio Access Network (CRAN) architecture, resources within a fronthaul network may be shared among multiple radio frequency (RF) nodes and baseband nodes. The traffic originated from RF nodes, baseband nodes, intermediate nodes in between, and timing units are routed with the fronthaul network and referred to as fronthaul traffic.

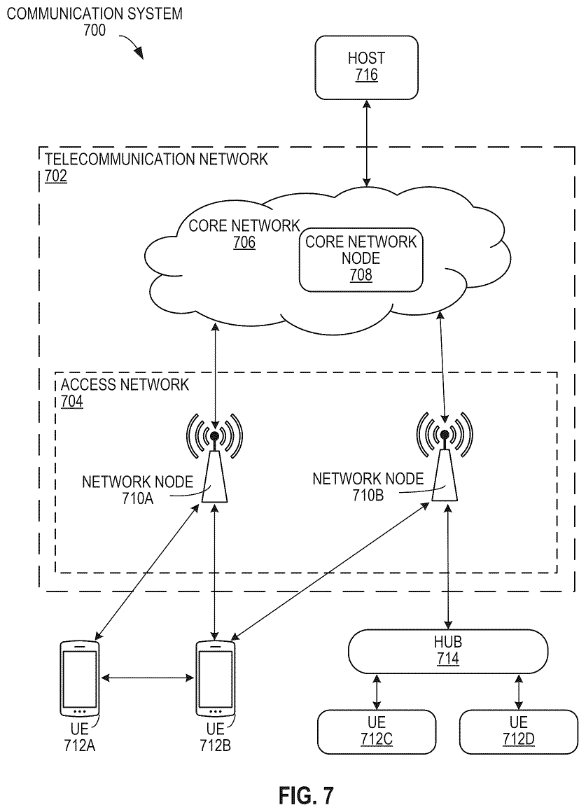

A RF node is responsible for transmitting and receiving radio signals over the air interface, and it may also be referred to as (remote) radio unit (RRU or RU), remote antenna unit (RAU), remote radio head (RRH), radio processing node, radio node, or distributed antenna system (DAS) node. A baseband node is responsible for processing the baseband signals and managing the radio resources, and it may also be referred to as baseband unit (BBU or BU), baseband processing unit (BPU), baseband controller (BBC), and digital unit (DU). In some embodiments, a baseband may be fully or partially virtualized. In that case, a baseband node may refer to one or more nodes implementing baseband processing functionality. Additionally, Open Radio Access Network (O-RAN) Alliance also defines an open radio unit (O-RU), an open distributed unit (O-DU), an open control unit (O-CU) for its fronthaul network architecture as discussed herein below relating to FIG. 7. The embodiments of the invention are applicable to systems using these other terms for the RF and baseband nodes described herein.

Various approaches for sharing the fronthaul network resources include dimensioning the network for peak rate, relying on packet marking, and/or executing traffic dropping by intermediate nodes, and enforcing rate limitations in the outbound interface (queueing disciplines).

Some approaches for sharing fronthaul network resources depend only on baseband nodes to coordinate scheduling decisions between radio nodes that share the same fronthaul network. For example, multiple schedulers may be coordinated to avoid distributing assignments/grants above a threshold thus not to surpass limitations in the fronthaul links.

Additionally, if baseband nodes are from the same vendor, a proprietary interface between the baseband nodes could be used to coordinate scheduling such that the total fronthaul capacity is not exceeded. However, while standardization bodies like the O-RAN Alliance have developed a set of specifications to promote an open, interoperable RAN architecture, no standardized interface between baseband nodes or between RF nodes is available for multiple baseband nodes to coordinate scheduling based on fronthaul capacity limitations. Accordingly, interoperable scheduling among nodes from multiple different vendors does not exist.

The management of a fronthaul network is decided based the fronthaul network's state, including available resources. One such decision is to drop data due to, e.g., limited fronthaul capacity. Furthermore, the fluctuation of demand requires both the radio access technology and the fronthaul interface implementation to efficiently use resources, which implies an interdependence between fronthaul resource allocation, and the amount of service provided to User Equipment (UEs) (see detailed description about UE in FIG. 7 regarding UEs 712A-D).

Although fronthaul link utilization fluctuates with the number of UEs being served, the fluctuation only relates to UEs currently receiving or transmitting data. A mobile network cell thus may admit and maintain many more “idle” UEs—UEs that are attached to the mobile network cell without incurring significant additional fronthaul demand—as only the UEs that are active (also referred to “awake” UEs) use fronthaul network resources for data transmission.

More specifically, the UE attachment procedure is such that there is no actual bidirectional communication between a base station and a UE until the master information block (MIB) and/or system information block (SIB) is received and decoded by the UE. After the MIB and/or SIB are received and decoded by the UE, the UE issues a Random Access Channel (RACH) request, upon that the UE has finalized its synchronization procedure and notified the cell of its existence by making a radio resource control (RRC) setup request. The RRC setup request (referred to as RRCSetupRequest in 3GPP) from the UE is transmitted using the signal radio bearer (SRB0) allocated to the UE through the RACH request.

In a CRAN architecture, a base station typically refers to a RF and baseband node pair, which may be a one-to-one or one-to-many mapping. Although referred to as a pair, in various embodiments, a RF and baseband node pair may include one or more RF nodes coupled to one or more baseband nodes to provide functionalities of a base station to serve any number of UEs. The UE(s) served by the RF node and baseband node pair may not be aware of the structure of the RF and baseband node pair that is providing base station functionalities to the UE(s).

In the CRAN architecture, the normal operations of the either RF nodes or baseband nodes hardware/software can be interrupted. For example, node (e.g., RF node or baseband node) could be rebooted in response to detection of a hardware/software failure on the node. As another example, a virtualized component within a RF node or a baseband node (e.g., a virtual machine (VM) or a software container) could fail and need to be reset. Additionally, in some scenarios, one or more intermediate nodes could be located between the RF node(s) and baseband node(s). If an intermediate node between an RF node and a baseband node experiences hardware and/or software issues, services provided by the RF node and baseband node could be interrupted. Even without operational anomalies, periodic maintenance operations (e.g., reconfiguring, upgrading, rebooting, and/or the like) could be performed on one or more these nodes and/or one or more services/functions executing on these nodes. The periodic maintenance operations can also cause interruption to communication between the RF and baseband node pair and the UEs served by the RF and baseband node pair.

The operation interruptions can have varying levels of duration, i.e., are expected to last for different amounts of time. For example, full computer boot sequences can range from seconds to minutes depending on the complexity of the system. During the interruption of normal operation, a cell being served by the affected RF node and/or baseband node is effectively shut down, and UEs being served by the cell experience a cell service outage, such as service interruption or coverage degradation. In the event of a cell service outage, the affected UEs will search neighbor cells for coverage.

The added random-access requests by the UEs due to unavailability of the interrupted cell will cause a drop in system performance (and, accordingly, user satisfaction) at the neighbor cells if the neighbor cells cannot serve the additional UEs coming in from the interrupted cell. For example, a CRAN fronthaul network could have four cells that equally divide the fronthaul network resources (i.e., each cell can only utilize 25% of fronthaul network resources). If one of the cells experiences an outage but the resource allocation for the remaining cells is not changed or adjusted, then the total resources usage would only amount to 75% of fronthaul network resources instead of 100%. Additionally, some of the affected UEs in the remaining cells may be denied service because of the outdated configuration. That is, a UE could be within the coverage area of a nearby cell (i.e., one of the remaining three cells) and the fronthaul is not currently fully loaded, but the nearby cell denies new attachments because this would exceed its allocated 25% share. Therefore, an anomaly in the RF node and/or baseband node serving a single cell in the CRAN fronthaul network could result in significant loss of fronthaul efficiency for the CRAN fronthaul network as a whole.

Such inefficiency of sharing the fronthaul network resources in previous approaches may be addressed through dynamically allocating fronthaul network resources based on RACH requests per some embodiments.

### Fronthaul Network Resource Allocation Based on RACH Requests

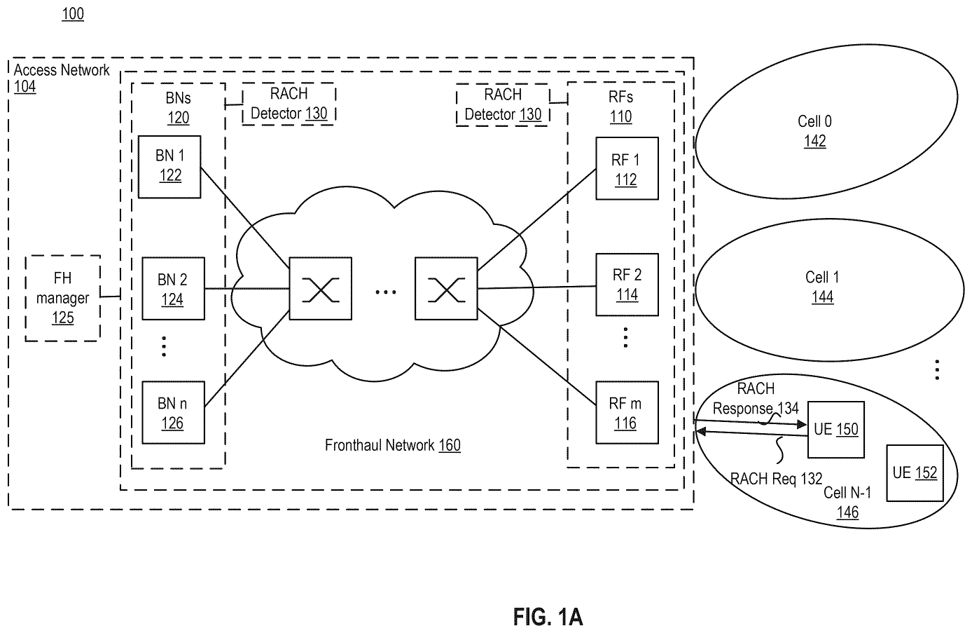

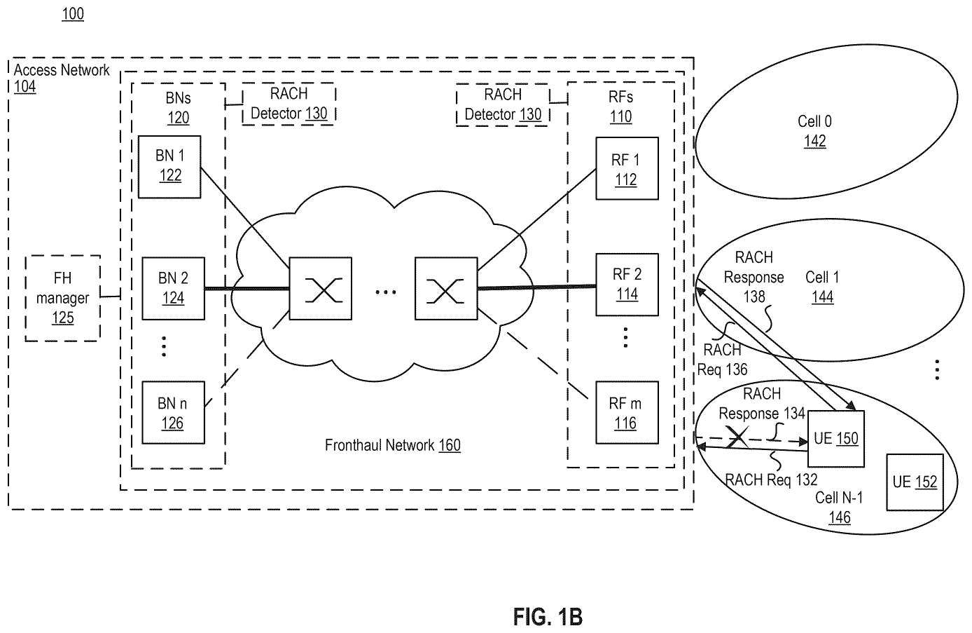

FIGS. 1A-1B illustrate fronthaul network resource reallocation upon a cell service outage per some embodiments. As shown in FIG. 1A, a system 100 includes an access network 104 that interacts with UEs such as UEs 150 to 152. In some embodiments, access network 104 is similar to 152. Access network 104 includes a fronthaul network 160.

The fronthaul network 160 includes a set of baseband nodes (BN) 1 to n, as shown at references 122 to 126, and a set of RF nodes 1 to m, as shown at references 110 to 116. A RF node and its corresponding baseband node are not directly coupled in some cases but are instead connected via one or more intermediate nodes. For example, intermediate switches/forwarding nodes along a path between a given baseband node and RF node may execute store-and-forward operations so that fronthaul data and control signaling (including synchronization) can traverse the fronthaul network between the two nodes. In various implementations, multiple intermediate nodes could be used to connect a baseband node to a corresponding RF node. For example, in indoor deployments where RF units are scattered across multiple floor levels, a switch may be implemented at each floor to connect the RF units on that floor.

As shown in system 100, the baseband nodes are logically clustered to one side while the RF nodes are clustered to another, and the two sides are coupled through one or more intermediate nodes. A topology like this is referred to as the dumbbell topology of a fronthaul network. Alternatively, a single baseband node may be coupled to a cluster of RF nodes through the intermediate nodes, and such topology is referred to as the tree topology. In the figure, the collection of baseband nodes is shown as baseband nodes 120, while the collection of RF nodes is shown as RF nodes 110. The embodiments of the invention support these and other topologies of fronthaul networks.

The fronthaul network serves the cells implemented by the RF nodes of the fronthaul network 160. In this example, Cells 0, 1, to N−1 (at references 142, 144, to 146) are implemented through the RF nodes at references 110 to 116. The number of RF nodes (m) is not necessarily equal to the number of cells (N). In some embodiments, one RF node may be used to implement multiple cells. In some embodiments, one cell may be implemented through multiple RF nodes, which is referred to as a shared cell or a single frequency network (SFN). A shared cell or SFN could be used, for example, to deliver high-quality, low-latency content such as video or audio streams to multiple UEs.

A RACH detector 130 may be implemented to detect the volume of RACH requests as discussed in more details herein below. RACH detector 130 may be implemented at various locations to serve fronthaul network 160. For example, RACH detector 130 may be integrated within a RACH receiver in a RF node, and it may be added to the RF node as a separate module/logic/circuit or a software module in the RF node. Implementing RACH detector 130 close to or at a RF node may result in earlier RACH signal storm detection than implementing RACH detector 130 in an intermediate node or a baseband node, but latter implementations are feasible and can be advantageous in some embodiments. For example, RACH detector 130 may be implemented in a PRACH (Physical Random Access Channel) receiver at a baseband node. Implementing RACH detector 130 at or close to a baseband shorten the communication path between RACH detector and fronthaul manager/scheduler (a fronthaul manager 125 is shown). Additionally, RACH detector 130 may be integrated with a fronthaul manager or scheduler, for example, when one vendor manufactures the fronthaul manager or scheduler. A RACH signal storm, as detected by RACH detector 130, occurs when the number of RACH requests in a time period exceeds a threshold. The RACH signal storm from a cell implies an impending increase in demand for resources to serve the cell, as it occurs in scenarios such as UEs migrating from another cell. The increasing demand requires the allocation of more resources to the cell serving these RACH requests and subsequent operations.

Also shown in FIG. 1A is fronthaul manager 125. Fronthaul manager 125, also referred to as a fronthaul resource manager or controller, is responsible for, among other functions, the management and control of the fronthaul network. It acts as an interface between the baseband and RF nodes, ensuring that the radio equipment is properly configured and that the data being transmitted is received correctly. The fronthaul manager is also responsible for monitoring the health and performance of the fronthaul network, diagnosing and resolving any issues that arise, and managing the resources required for the transmission of data. A fronthaul scheduler is responsible for, among other functions, scheduling the transmission of data between the baseband and RF nodes, and it ensures that data is transmitted at the right time and in the right order, optimizing the use of available network resources and minimizing delays and latency. The fronthaul scheduler also manages the allocation of bandwidth and other network resources, ensuring that the network is used efficiently, and that data is transmitted with the required quality of service (QoS). Fronthaul manager 125 may be within or coupled to fronthaul network 160. When it is implemented within fronthaul network 160, it may be within or coupled to one or more baseband nodes, RF nodes, and/or intermediate nodes. While the fronthaul manager and scheduler may be implemented separately, they may be integrated as a single node/module/unit in some embodiments.

The sets of baseband nodes and RF nodes share fronthaul network resources. The resource sharing may be configured by the fronthaul manager 125. To share the fronthaul network resources, a fronthaul network resource may be dedicated (also referred to as reserved, configured, preserved, etc.) to one of the served cells. The dedicated fronthaul network resource is then prioritized or guaranteed to that corresponding cell. When a fronthaul network resource is prioritized to a cell, the cell takes precedence over another cell when both cells request the fronthaul network resource; and when fronthaul network resource is guaranteed to a cell, the cell alone may use the fronthaul network resource.

A variety of resources within the fronthaul network may be shared among the cells. For example, a cell may be configured with prioritized or guaranteed bandwidths of links, wavelengths of links, routes (e.g., ones dedicated to the cell being differentiable through virtual local area network (VLAN)), scheduled timeslots (e.g., timeslots as defined by the Time-Sensitive Networking (TSN) standards), resources proportional to the expected traffic demand. These resources proportional to the expected traffic demand could scale with (1) the number of physical resource blocks (PRBs) dedicated to the cell, and/or (2) the number of UEs in the cell (e.g., the cell to which UEs are migrating).

A set of UEs are served in Cell N−1 and communicate with RF node 116 in normal operations, as RF node 116 implements the cell. The UEs are shown as UEs 150 and 152 as examples, where UE 150 issues a Random Access Channel (RACH) request 132 over the corresponding RACH channel to RF node 116 to request access to access network 104 through the fronthaul network 160. UE 150 may select a random access preamble from a predefined set of preambles and transmits it over the RACH channel to RF node 116. RF node 116 may then relay a RACH response 134 from the corresponding baseband node 126, indicating whether the preamble was successfully received or not. If the preamble was successfully received, UE 150 can then proceed to transmit or receive the actual data for services provided through the fronthaul network 160.

In normal operation, the RACH requests and responses are exchanged between UEs in Cell 146 and RF node 116. Yet the normal operation of RF node 116, its corresponding baseband node (baseband node 126 in this example), an intermediate node between RF node 116 or baseband node 126, or another node/module/unit (e.g., timing unit in the network) may be interrupted due to e.g., operational anomalies and/or periodic maintenance operations discussed herein above.

FIG. 1B illustrates fronthaul network resource reallocation per some embodiments. When the normal operation of these nodes is interrupted, the RACH request 132 will not be acknowledged successfully and UE 150 cannot transmit or receive the actual data through Cell 146. In the figure, the RACH response 134 that does not reach UE 150 is marked with a cross.

UE 150 will then search and find a neighbor cell (Cell 144 in this example) to send a RACH request 136. Since RF node 114 and its corresponding baseband node 124 operate normally, RF node 114 and the corresponding baseband node 124 will attempt to accommodate the additional workload from UE 150, even though UE 150 is not in the cell it serves normally.

When the normal operation in Cell 146 is interrupted, other UEs (e.g., UE 152) in the cell will try to get served by a neighbor cell as well, and RF node 114 may experience a RACH signal storm due to all the additional RACH requests from Cell 146. To accommodate such signal storm, a RACH detector 130 may be implemented to detect the volume of RACH requests. When RACH requests received at a RF node reach a threshold (e.g., the RACH signal storm is detected), the fronthaul network resource may be reconfigured so that the RF node, its corresponding baseband node(s), and/or intermediate node(s) between these nodes may obtain resources that were dedicated to the nodes serving the interrupted cell, so that the nodes may now serve the additional workloads (following the additional RACH requests from the interrupted cell). In this example, the reconfiguration causes fronthaul network resources for Cell 146 to be made available to Cell 144, and the fronthaul network resources that are accumulated for Cell 144 are shown as the thickened lines to RF node 114 and baseband node 124. With the accumulated fronthaul network resources for Cell 144, the RACH request 136 may be responded with RACH response 138. Through the resource reconfiguration, the RACH signal storm and subsequent operations with the additional UEs in Cell 144 are served through the fronthaul network resources now made available to Cell 144, and the UEs in the interrupted Cell 146 will not experience service outage/degradation. Thus, the resource reconfiguration of the fronthaul network 160 among cells improves the overall performance of the access network 104.

Once RACH detector 130 counts that the RACH requests received at a RF node reach a threshold, RACH detector 130 may issue a notification to a fronthaul manager; the effect of which is to reconfigure (or perhaps simply “violate”) predetermined fronthaul resource allocations for the purposes of picking up demand from a possibly unavailable neighbor cell. In this context, violating the predetermined fronthaul resource allocations is a reconfiguration in which the predetermined fronthaul resource allocations are no longer observed (for the duration of the service disruption), e.g., fronthaul network resources that were dedicated to Cell 146 are now made available for Cell 144 to accommodate the RACH signal storm and subsequent operations with the additional UEs in Cell 144.

Through detecting the volume of RACH requests, the fronthaul manager may reconfigure the fronthaul network resources accordingly without adhering to the predetermined fronthaul sources allocation. Such reconfiguration shifts away fronthaul network resources that were dedicated to a cell that is experiencing service outage, and since the reconfiguration uses these fronthaul network resources to address the RACH signal storm caused by the cell service outage, the reconfiguration enhances the performance of the UEs leaving the cell with service outage and allows the cell taking in the additional UEs to accommodate the additional workload. Accordingly, the reconfiguration increases overall resource usage efficiency of the fronthaul network.

### Threshold Determination and Fronthaul Network Resource Configuration

To properly detect a RACH signal storm, the correct threshold value needs to be determined so that it is not too low to cause a false alarm, where the increase of the RACH requests at a given period is due to normal operation, not service interruption in a neighbor cell. On the other hand, the threshold cannot be too high to miss real RACH signal storm due to the service interruption.

In a cell, RACH requests are issued for the initial access by a UE (connection establishment), or connection reestablishment by the UE connection (as shown as RACH requests 132 and 136). These are the RACH requests that may cause the RACH signal storm.

Yet two other events may also entail issuing RACH requests when a cell operates normally. One of them is for uplink data transmission. When a UE has uplink data to transmit (e.g., as determined at the MAC layer while the UE is in RRC_inactive state), a RACH procedure including one or more RACH requests is necessary before a Scheduling Request (SR) can be issued.

The other event is for handover. When a UE moves from one cell to another, it needs to perform a handover. The UE uses the RACH request resources in the new cell by sending a random access request. Via PRACH and RRC messages, the new cell and the UE synchronize, establish the connection, and then transmit/receive the data for services.

In both cases, the occurrence of the events is not expected to be so numerous as to cause a RACH signal storm. The threshold value should be higher than the number of RACH requests triggered by expected RACH requests in a cell, e.g., based on the number of active UEs and expected RACH for either uplink data transmission or handover of these active UEs in the cell. Additionally, other configuration information may be used to determine the threshold value, including the configured paging cycle, the average discontinuous reception (DRX) cycle lengths of attached UEs, and the number R of contention-based preambles per Synchronization Signal Block (SSB). From these metrics and some assumed percentage p of attached UEs usually waking up (where N_{healthy} denotes the number of non-idle UEs), it is possible to derive a minimum threshold for detection of RACH signal storms using the following with a given count period Timer:

$${wake}_{\{ frames \}} = min ( avg \cdot DRX cycle , paging cycle ) \qquad ( 1 )$$

$${N}_{healthy} = p * {attached}_{\{ UEs \}}$$

$${N}_{healthy} * \frac{{T}_{timer}}{{wake}_{\{ frames \}} * 10 ms} < Count Threshold$$

Formulae (1) determines the lower bound of the threshold value, Count Threshold. The assumption is that there are R preambles (and therefore R “usable” RACH requests) in one RACH period-which is usually 1 radio frame. The upper bound of the RACH requests that can be served simultaneously may also be determined as

$$Count Threshold < R * \frac{{T}_{timer}}{{RACH}_{period}} .$$

Note that the configuration could be used with multiple radio frames in one RACH period, e.g., 16. This is because UEs are expected to be distributed throughout the cell's coverage area, so the actual SSB that their RACH requests correspond to would be random. For heavily loaded cells, though, the upper bound could be multiplied by, e.g., the number of SSBs.

Once the threshold is crossed, a request to reconfigure fronthaul network resources is triggered. In some embodiments, the fronthaul manager reconfigures the fronthaul network resources based on the request. Since the fronthaul manager is aware of how many cells are competing for a specific segment of the fronthaul, it can use the “original” allocation as the baseline to reconfigure resources from being dedicated to one cell (with service interruption) to being dedicated to another cell (without service interruption and with additional RACH requests due to the interruption of the former cell).

For example, in one deployment, the baseline configuration is to configure equal shares (ci) for all cells (N). Due to service disruption at the first cell, all UEs from the first cell have migrated to only one of the neighbor cells, the second cell. In that case, the initial configuration would be:

$${c}_{i} = \frac{1}{N} , i = 0 , 1 , ... , N - 1 \qquad ( 2 )$$

and then the updated configurations for the cells are:

$${c}_{0}^{′} = 0 \qquad ( 3 )$$

$${c}_{1}^{′} = \frac{2}{N}$$

$${c}_{i}^{′} = \frac{1}{N} i = 2 , 3 , ... , N - 1$$

In Formulae (3),

$${c}_{i}^{′}$$

is the new configuration for each cell i, considering cell 0 has shut down and cell 1 has received the former's entire fronthaul network resource share.

Naturally, depending on the position of each UE in the original cell, it is more likely that the demand is spread out between all neighbor cells, and not necessarily equally. Thus, one strategy for the reconfiguration could then be to make use of the timer's interval (Tₜᵢₘₑᵣ), comparing it to an expected cell interrupt time (Tᵢₙₜₑᵣᵣᵤₚₜ) of the original cell, and use this fraction as an incremental percentage:

$${c}_{i}^{( t )} = {c}_{i}^{( t - 1 )} + \frac{{T}_{timer}}{{T}_{interrupt}} C \qquad ( 4 )$$

In Formula (4), t denotes (discrete) time and C denotes some baseline fronthaul network resource share (e.g., 1/N or the average fronthaul network resource share in the deployment), since at this point it is not known which cell has shut down. The assumption here is that, after Tᵢₙₜₑᵣᵣᵤₚₜ seconds have elapsed, the original cell is expected to return to normal operation (e.g., after power cycle of a RF/baseband node) and the UEs will reattach to the original cell as they detect the stronger signal nearby.

For increased granularity, the increment can be further weighted by the percentage of detected RACHs:

$${c}_{i}^{( t )} = {c}_{i}^{( t - 1 )} + \frac{{T}_{timer}}{{T}_{interrupt}} * \frac{count}{R * \frac{{T}_{timer}}{{RACH}_{period}}} C \qquad ( 5 )$$

Based on the determined increment, the fronthaul network resources may be reconfigured over several time intervals t to adjust to the changed workloads at the cells to address the RACH signal storm due to cell service interruption.

While the equal sharing of the fronthaul network resources is discussed as an example, some embodiments may adjust the fronthaul network resource allocation when the fronthaul network resources are shared differently. For example, more sophisticated schemes for cell prioritization (and therefore fronthaul network resource reallocation) could rely on, for example, communication between the schedulers for the RF/baseband nodes and corresponding cells.

### Exemplary Fronthaul Network Resource Reconfiguration Upon Cell Service Interruption

As discussed herein above, the fronthaul network resources may be reconfigured upon cell service interruption. The reconfiguration with and without implementing the dynamic fronthaul network resource allocation discussed herein is shown through the following figures.

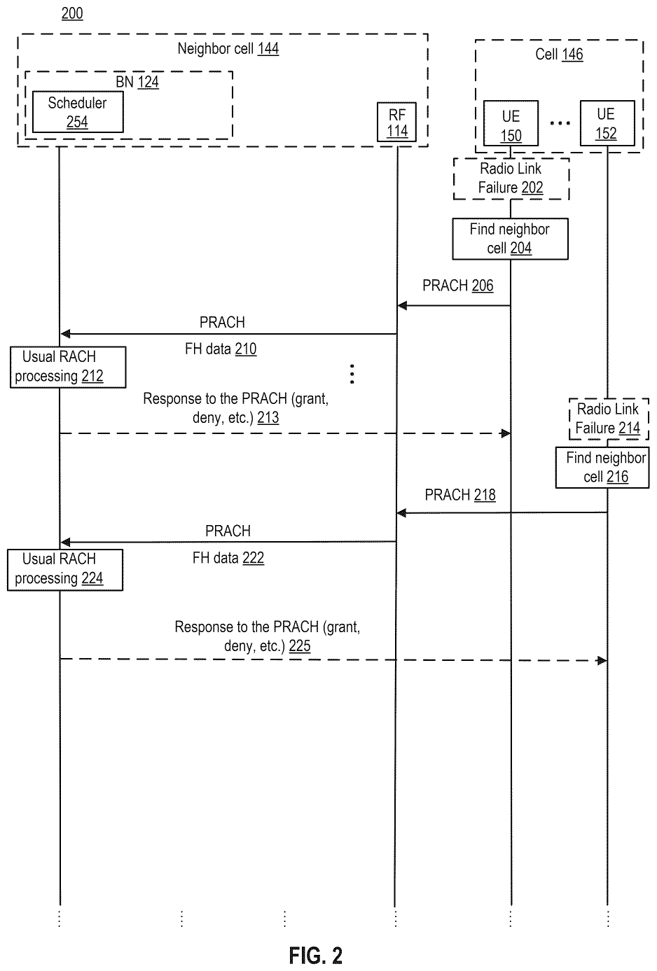

FIG. 2 illustrates fronthaul network operations when UEs join a neighbor cell. In System 200, UEs 150 to 152 are served by Cell 146 while the neighbor cell is Cell 144, which is implemented through the pair of RF node 114 and baseband node 124, as shown in FIG. 1. A scheduler 254 schedules the transmission of data between baseband and RF nodes, which happens over the fronthaul interface.

At reference 202, UE 150 detects that Cell 146 is no longer responsive to UE 150, and the non-responsiveness may be due to the radio link failure (e.g., RF node 116 that implements Cell 146 is in a reset cycle). Alternatively, the non-responsiveness may be due to other operational anomalies and/or periodic maintenance operations in the fronthaul network 160 to cause service interruption in Cell 146. With the detection of service interruption in Cell 146, UE 150 searches to find neighbor cells to provide services at reference 204. Once it finds Cell 144 as its neighbor cell, it sends a RACH request to RF node 114 for Cell 144 through a dedicated physical channel, PRACH, including random access preambles at reference 206. The embedded RACH request for a random access procedure is then sent to scheduler 254 as part of the regular fronthaul data traffic at reference 210. The regular fronthaul data traffic includes one or more of (1) the uplink and downlink (UL/DL) signals, (2) (air interface) control messages beamforming coefficients, precoding matrices, TDD slot configuration, and (3) control messages for the nodes themselves, such as configurations for the power amplifier, radio frontend, management messages (e.g., health status of RF nodes).

Baseband node 124 then determines and processes the embedded RACH request as usual RACH processing at reference 212. The usual RACH processing includes, for example, timing advance estimation, contention resolution, and RACH response to the RACH request. Baseband node 124 may respond to the RACH request at reference 213 with operations such as (1) granting access if fronthaul network resources dedicated to Cell 144 are available to accommodate UE 150 by e.g., sending a RACH response message that includes the necessary resources for UE 150 to proceed with communication in Cell 144, (2) denying access if fronthaul network resources dedicated to Cell 144 are not available to accommodate UE 150, and (3) resolving contention if multiple UEs (e.g., both UEs 150 and 152) are transmitting RACH requests simultaneously (e.g., through random backoff).

Baseband node 124 performs similar usual RACH processing at references 224 and 225 in response to RACH 222 received due to RACH 218 initiated by UE 152, which is served by the interrupted Cell 146 and responds similarly as UE 150 as shown at references 214 and 216.

The above operations process the RACH requests individually, regardless of the cause of the RACH requests and whether or not a RACH signal storm has formed. Scheduler 254 and/or baseband node 124 operate based on the limited fronthaul network resources dedicated to Cell 144, without the awareness that Cell 146 being interrupted and the fronthaul network resources dedicated to Cell 146 becoming available to Cell 144 to accommodate UEs that were served by Cell 146 and that are requesting services by Cell 144. Since scheduler 254 and baseband node 124 do not consider the temporary RACH signal storm due to the service outage at Cell 146 and not leverage available resources for Cell 146, such fronthaul network resource allocation is less than optimal and may result in degradation of service performance and user satisfaction. For example, the RACH signal storm may cause service outage for some UEs, either the ones originally served by Cell 144 and requesting a reconnect or ones originally served by Cell 146 and requesting migration to Cell 144.

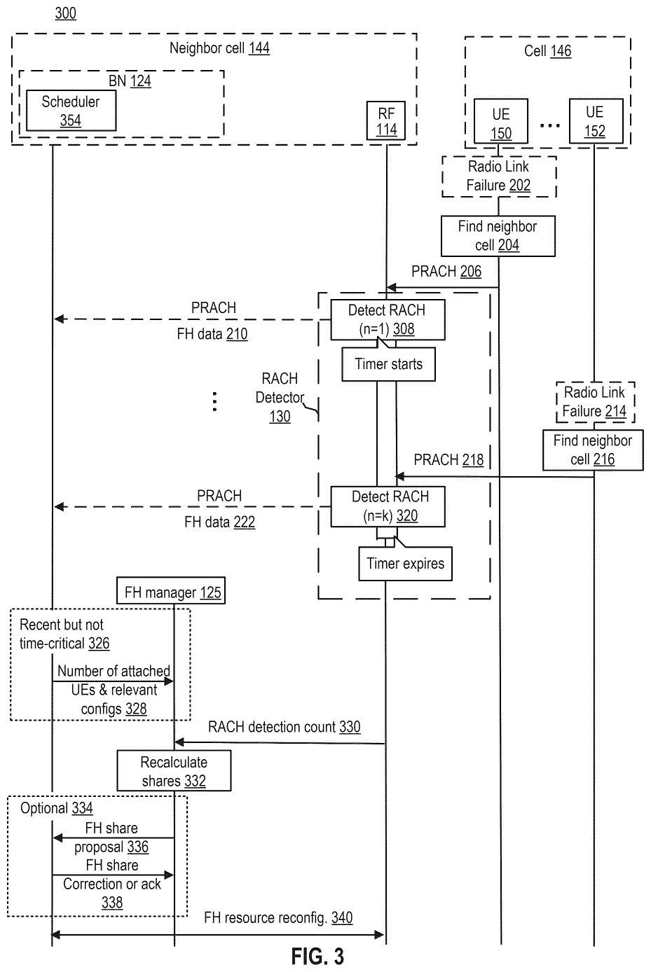

FIG. 3 illustrates fronthaul network resource reconfiguration through a first set of embodiments. System 300 includes the same UEs and cells as the ones in System 200, but the former includes fronthaul manager 125 that manages fronthaul network resources. A single fronthaul manager 125 may be shared by all the baseband and RF nodes of a fronthaul network in some embodiments, while other embodiments may include multiple fronthaul managers, each managing a set of resources of the fronthaul network. While fronthaul manager 125 is shown separately from scheduler 354 and RACH detector 130, some or all of these entities may be integrated as a single module/logic/circuit or a software module within a fronthaul network.

Upon receiving the RACH request to RF node 114 for Cell 144 at reference 206, RACH detector 130 detects the RACH request at reference 308, counts up to the detection of the RACH request at reference 320 and determines how many RACH requests have been received in a given time (e.g., through a timer). The timer may be triggered by the detection of a first RACH request, or a certain periodic reset. The duration of the timer is Tₜᵢₘₑᵣ discussed herein above, and it can be predetermined and/or adjusted during runtime. In this embodiment, RACH detector 130 is implemented at or near a RF node (RF node 114 in this example), and it counts all the RACH requests received prior to expiration of the timer.

While RACH detector 130 counts RACH requests, fronthaul manager 125 may receive relevant information that is recent but not necessarily real-time (not time critical) in box 326, where the relevant information to determine a threshold value is provided, including (1) the number of attached UEs and how many of them are likely awake, and (2) relevant configuration of the radio access technology such as the DRX cycle lengths at reference 328. For example, the relevant information includes the parameters to determine the minimum threshold value based on Formulae (1). Note that Formulae (1) provides only the minimum threshold value, and a different threshold value may be set based on additional factors, e.g., timing requirement to provide real-time streaming services to UEs.

RACH detector 130 provides the detected RACH request count to fronthaul manager 125 at reference 330 for fronthaul manager to determine whether the RACH request count is over the threshold. Note that in some embodiments (e.g., when RACH detector 130 is integrated with fronthaul manager 125), the RACH request count number itself is not provided, an indication of threshold crossing is provided to fronthaul manager 125 instead, in that case the allocation according to the RACH request count number (e.g., Formula (5) won't be used but the allocation based on the occurrence of threshold crossing (e.g., Formula (4)) is still applicable.

Once fronthaul manager 125 determines that the threshold has been crossed, fronthaul manager 125 recalculates the shares of fronthaul network resources dedicated to Cell 144 at reference 332. The revaluation of the shares may use Formulae (2) to (5) explained herein above.

In some embodiments, optional operations in box 334 are performed (e.g., by the baseband node 124). A resource reconfiguration request may be sent at reference 336 with a recalculated fronthaul share proposal for Cell 144 to scheduler 354, which may acknowledge the proposed fronthaul share for Cell 144 or counter propose a different share for Cell 144. One or more rounds of proposal and counterproposal may be exchanged before the new shares for Cell 144 are agreed. At reference 340, the fronthaul network resource reconfiguration is performed to implement the new shares for Cell 144. The resource reconfiguration may happen incrementally through a few time intervals as expressed in Formulae (4) to (5) in some embodiments.

The adjusted fronthaul network resource share is then used to serve the additional RACH requests so that the RACH signal storm may be mitigated with the additional fronthaul network resources.

Note that while only the recalculation of resource shares for Cell 144 is illustrated, more than one cell may be included in the recalculation. The cell outage of Cell 146 may cause RACH signal storms on other neighbor cells, and they may be involved to determine the proper resource shares for all the operating cells. Also, many factors may be considered to be relevant to decide the resource shares for Cell 144, e.g., the size of cells, and the RACH counts at other cells of the fronthaul network.

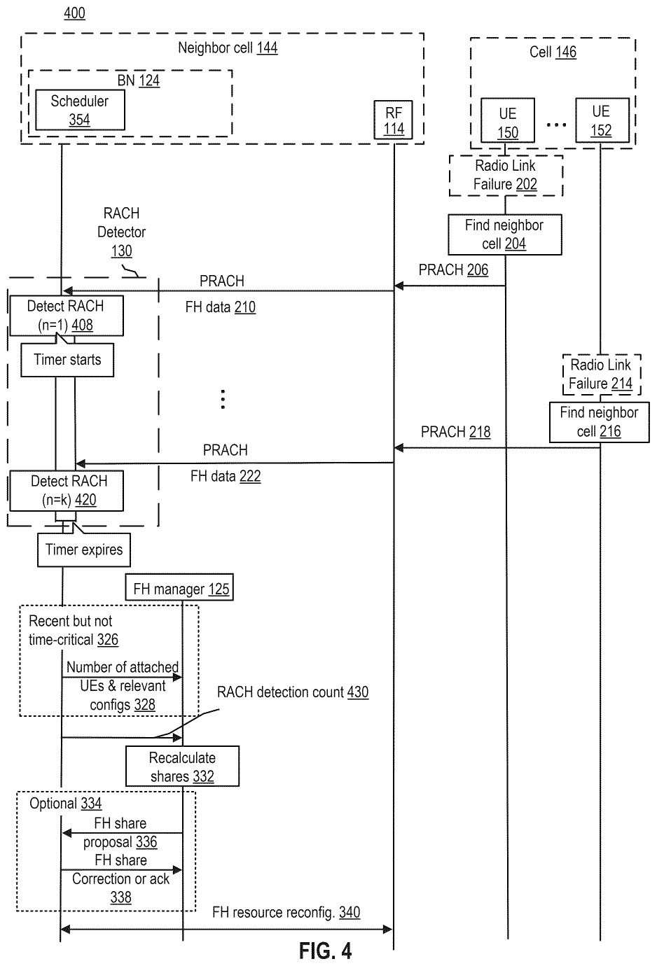

FIG. 4 illustrates fronthaul network resource reconfiguration through a second set of embodiments. System 400 includes the same entities as in System 300, but RACH detector 130 is to be implemented at or close to a baseband node (baseband node 124) in FIG. 4 instead of being at or close to a RF node (RF node 114) in FIG. 3. Accordingly, RACH detection count at reference 430 is received from the baseband node 124 (instead of RACH detection count at reference 330 received from the RF node 114), where the detections at references 408 to 420 is similar to the ones at references 308 to 320, respectively.

Note that while the usual RACH processing 212 and 224 are not shown at FIGS. 3 and 4, they are performed as part of the regular operation, along with the reconfiguration of fronthaul network resources.

Also, the RACH signal storm may be temporary. The RACH signal storm is caused by cell service outage, due to operational anomalies, periodic maintenance operations, or other events. For example, Cell 146 can be restored after a duration through fixing the underlying issues, completing the maintenance operations (e.g., rebooting a RF node, a baseband node, an intermediate node in between, or a virtualized component within one or more of these nodes), or performing other operations. Once Cell 146 restores, the RACH request from the UEs that were originally served by Cell 146 will be sent to Cell 146, which may count the RACH request, and once the RACH request count reaches a threshold, the resource reconfiguration may be triggered, and the resources that were made available to Cell 144 may now be converted back to Cell 146. Thus, the RACH detector for different cells may maintain only a single threshold for reconfiguration to trigger the fronthaul network resource reconfiguration.

### Operations Per Some Embodiments

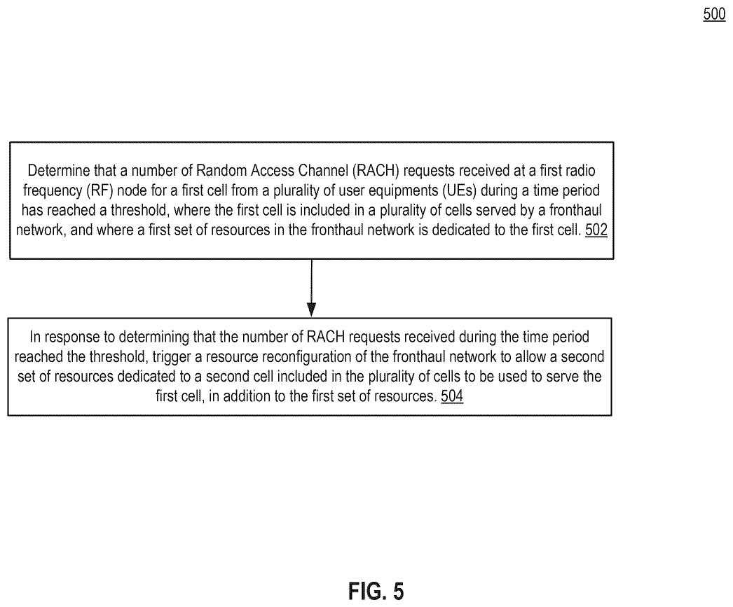

FIG. 5 is a flow diagram illustrating the operations of allocating fronthaul network resources based on random access channel (RACH) requests per some embodiments. Method 500 may be implemented in a fronthaul manager such as fronthaul manager 125 in some embodiments. Note that the fronthaul manager may be integrated with other entities such as RACH detector and scheduler as discussed herein above.

At reference 502, it is determined that a number of Random Access Channel (RACH) requests received at a first radio frequency (RF) node for a first cell from a plurality of user equipments (UEs) during a time period has reached a threshold, where the first cell is included in a plurality of cells served by a fronthaul network, and where a first set of resources in the fronthaul network is dedicated to the first cell.

At reference 504, in response to determining that the number of RACH requests received during the time period reached the threshold, a resource reconfiguration of the fronthaul network is triggered to allow a second set of resources dedicated to a second cell included in the plurality of cells to be used to serve the first cell, in addition to the first set of resources.

In some embodiments, the threshold is based on at least one of a number of active UEs served by the first cell, a minimum period of an average duration of a discontinuous reception (DRX) cycle and a configured downlink paging cycle. For example, the threshold may be calculated to be a value calculated based on Formulae (1) to be larger than

$$Count Threshold ( e . g . , k + {N}_{healthy} * \frac{{T}_{timer}}{{wake}_{\{ frames \}} * 10 ms} ,$$

where k is an integer).

In some embodiments, a volume of the second set of resources to be used to serve the first cell is based on the time period and a maintenance duration for one or more of a RF node, a baseband node, and an intermediate node between the RF node and baseband node and within the fronthaul network. For example, the time period and maintenance duration are Tₜᵢₘₑᵣ and Tᵢₙₜₑᵣᵣᵤₚₜ respectively in Formulae (4) and (5) discussed herein above.

In some embodiments, the maintenance duration corresponds to an amount of time expected to perform one or more of rebooting, reconfiguring, or upgrading the following: at least one of the RF node, the baseband node, the intermediate node within the fronthaul network, or one or more functions of the RF node, one or more functions of the baseband node, or one or more functions of the intermediate node within the fronthaul network. A function may be a virtualized component such as a VM or a software container in some embodiments.

In some embodiments, the volume of the second set of resources to be used to serve the first cell is further based on the number of RACH requests received at the first RF node for the first cell over the time period. For example, the volume may be calculated based on Formula (5) discussed herein above.

In some embodiments, the threshold is based on a first number of RACH requests accumulated over the time period according to uplink data at the media access control (MAC) layer of UEs for the first cell. The existence of uplink data at the MAC layer of UEs for the first cell may be calculated using the average DRX cycle discussed herein above.

In some embodiments, the threshold is based on a second number of RACH requests accumulated over the time period according to UEs for the first cell responding to paging messages in downlink from the RF nodes for the first cell. The number of UEs for the first cell responding to paging messages in downlink may be inferred/estimated using the paging cycle discussed herein above.

In some embodiments, the second set of resources to be used to serve the first cell are proportional to expected traffic demand that was dedicated to the second cell prior to the reconfiguration.

In some embodiments, the second set of resources to be used to serve the first cell includes a link bandwidth in the fronthaul network that was prioritized or guaranteed to the second cell prior to the reconfiguration.

In some embodiments, the second set of resources to be used to serve the first cell include one or more timeslots that were prioritized or guaranteed to the second cell prior to the reconfiguration. For example, the timeslots may be the ones defined by the TSN standards.

In some embodiments, triggering the resource reconfiguration comprises sending a resource reconfiguration request to a baseband node (e.g., baseband node 124 performing the optional steps 334 to 338 with fronthaul manager 125), and the baseband node schedules the resource reconfiguration as requested or as available resources in the fronthaul network.

In some embodiments, the first set of resources and the second set of resources are assigned to serve the RACH requests and subsequent operations for UEs served by the first cell.

### Devices and Environments for Embodiments of the Invention

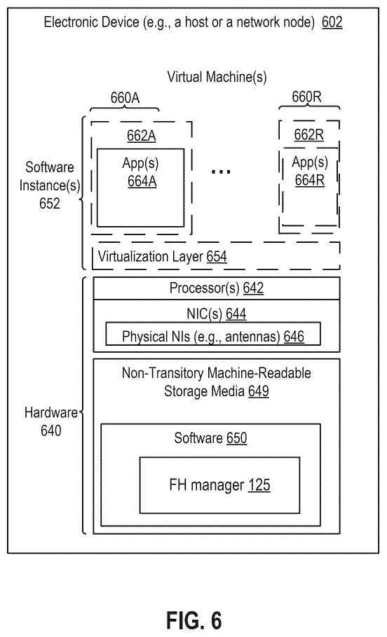

FIG. 6 illustrates an electronic device for allocating fronthaul network resources based on random access channel (RACH) requests per some embodiments. The electronic device may be a host in a cloud system, or a network node in a wireless/wireline network (e.g., within a fronthaul network), and the operating environment and further embodiments the host and the network node are discussed in more details herein below relating to FIGS. 7 to 12. The network node may be a RF node (e.g., one of RF nodes 112 to 116 in fronthaul network 160 in FIGS. 1A-1B), a baseband node (e.g., one of baseband nodes 122 to 126 in the same figure), an intermediate node in between the RF and baseband node, or another node in a fronthaul network. The electronic device 602 may be implemented using custom application specific integrated circuits (ASICs) as processors and a special-purpose operating system (OS), or common off-the-shelf (COTS) processors and a standard OS. In some embodiments, the electronic device 602 implements fronthaul manager 125 discussed herein.

The electronic device 602 includes hardware 640 comprising a set of one or more processors 642 (which are typically COTS processors or processor cores or ASICs) and physical NIs 646, as well as non-transitory machine-readable storage media 649 having stored therein software 650. During operation, the one or more processors 642 may execute the software 650 to instantiate one or more sets of one or more applications 664A-R. While one embodiment does not implement virtualization, alternative embodiments may use different forms of virtualization. For example, in one such alternative embodiment, the virtualization layer 654 represents the kernel of an operating system (or a shim executing on a base operating system) that allows for the creation of multiple instances 662A-R called software containers that may each be used to execute one (or more) of the sets of applications 664A-R. The multiple software containers (also called virtualization engines, virtual private servers, or jails) are user spaces (typically a virtual memory space) that are separate from each other and separate from the kernel space in which the operating system is run. The set of applications running in a given user space, unless explicitly allowed, cannot access the memory of the other processes. In another such alternative embodiment, the virtualization layer 654 represents a hypervisor (sometimes referred to as a virtual machine monitor (VMM)) or a hypervisor executing on top of a host operating system, and each of the sets of applications 664A-R run on top of a guest operating system within an instance 662A-R called a virtual machine (which may in some cases be considered a tightly isolated form of software container) that run on top of the hypervisor—the guest operating system and application may not know that they are running on a virtual machine as opposed to running on a “bare metal” host electronic device, or through para-virtualization the operating system and/or application may be aware of the presence of virtualization for optimization purposes. In yet other alternative embodiments, one, some, or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels, and sets of applications that are run in different software containers).

The software 650 contains fronthaul manager 125 that performs operations described with reference to operations as discussed relating to FIGS. 3 to 5. The fronthaul manager 125 may be instantiated within the applications 664A-R. The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual electronic device 660A-R.

A network interface (NI) may be physical or virtual. In the context of Internet Protocol (IP), an interface address is an IP address assigned to an NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). The NI is shown as network interface card (NIC) 644. The physical network interface 646 may include one or more antenna of the electronic device 602. An antenna port may or may not correspond to a physical antenna. The antenna comprises one or more radio interfaces.

### A Wireless Network Per Some Embodiments

FIG. 7 illustrates an example of a communication system 700 per some embodiments. In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710A and 710B (one or more of which may be generally referred to as network nodes 710), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 702 includes one or more Open-RAN (ORAN) network nodes. An ORAN network node is a node in the telecommunication network 702 that supports an ORAN specification (e.g., a specification published by the O-RAN Alliance, or any similar organization) and may operate alone or together with other nodes to implement one or more functionalities of any node in the telecommunication network 702, including one or more network nodes 710 and/or core network nodes 708. In some embodiments, the communication system 700 can be used to implement various aspects disclosed herein. For example, access network 704 may implement access network 104, UEs 712A-D may implement UEs 150 and 152.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes 710 facilitate direct or indirect connection of user equipment (UE), such as by connecting UEs 712A, 712B, 712C, and 712D (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702 and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multiple radio access technology (multi-RAT) or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712C and/or 712D) and network nodes (e.g., network node 710B). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a virtual reality (VR) headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular if one or more of the UEs are low energy IoT devices.

The hub 714 may have a constant/persistent or intermittent connection to the network node 710B. The hub 714 may also allow for a different communication scheme and/or schedule between the hub 714 and UEs (e.g., UE 712C and/or 712D), and between the hub 714 and the core network 706. In other examples, the hub 714 is connected to the core network 706 and/or one or more UEs via a wired connection. Moreover, the hub 714 may be configured to connect to a machine-to-machine (M2M) service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710B. In other embodiments, the hub 714 may be a non-dedicated hub—that is, a device which is capable of operating to route communications between the UEs and network node 710B, but which is additionally capable of operating as a communication start and/or end point for certain data channels.

### UE Per Some Embodiments

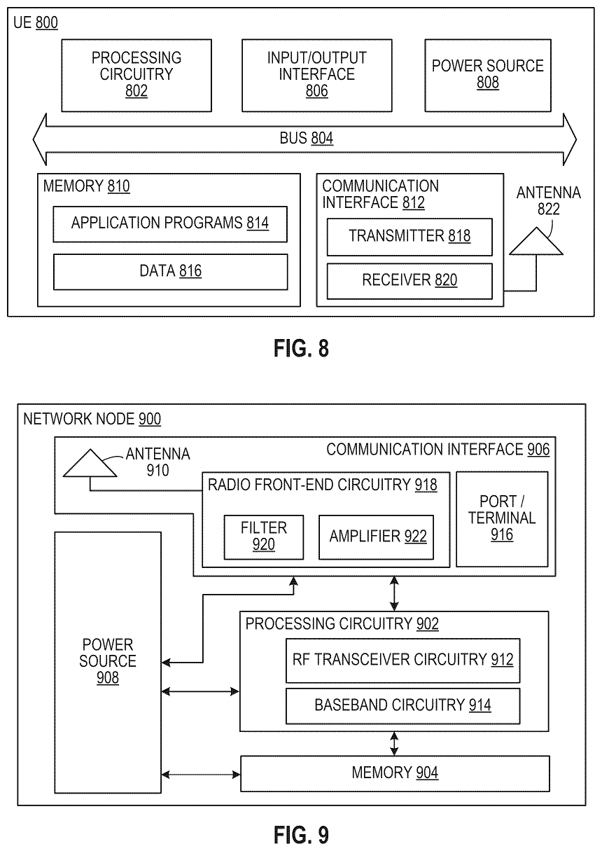

FIG. 8 illustrates a UE 800 per some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a Universal Subscriber Identity Module (USIM) and/or IP Multimedia Services Identity Module (ISIM), other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), Quick UDP Internet Connections (QUIC), Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

### Network Node Per Some Embodiments

FIG. 9 illustrates a network node 900 per some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900. In some embodiments, the network node 900 may implement fronthaul manager 125, which may integrate with RACH detector 130 and/or scheduler 354 and perform operations described herein.

### Host Per Some Embodiments

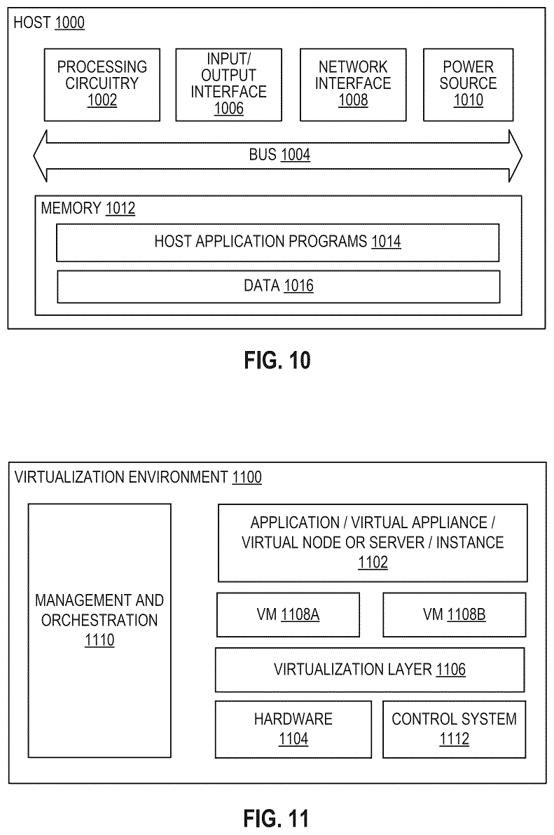

FIG. 10 is a block diagram of a host 1000, which may be an embodiment of the host 716 of FIG. 7, per various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs. In some embodiments, the host 1000 may implement fronthaul manager 125, which may integrate with RACH detector 130 and/or scheduler 354 and perform operations described herein.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

### Virtualization Environment Per Some Embodiments

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment 1100 includes components defined by the O-RAN Alliance, such as an O-Cloud environment orchestrated by a Service Management and Orchestration Framework via an O-2 interface.

Applications 1102 (which may alternatively be called software instances, virtual appliances, network functions, virtual nodes, virtual network functions, etc.) are run in the virtualization environment Q500 to implement some of the features, functions, and/or benefits of some of the embodiments disclosed herein. In some embodiments, the Applications 1102 may implement fronthaul manager 125, which may integrate with RACH detector 130 and/or scheduler 354 and perform operations described herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108A and 1108B (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g., such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

### Communication Among Host, Network Node, and UE Per Some Embodiments

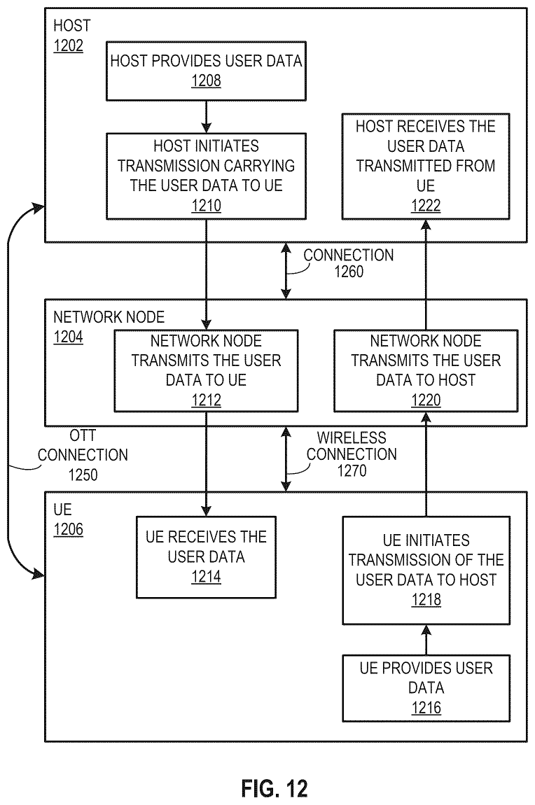

FIG. 12 illustrates a communication diagram of a host 1202 communicating via a network node 1204 with a UE 1206 over a partially wireless per some embodiments. Example implementations, in accordance with various embodiments, of the UE (such as a UE 712A of FIG. 7 and/or UE 800 of FIG. 8), network node (such as a network node 710 of FIG. 7 and/or network node 900 of FIG. 9), and host (such as host 716 of FIG. 7 and/or host 1000 of FIG. 10) discussed in the preceding paragraphs will now be described with reference to FIG. 12. Either host 1202 or network node 1204 may implement fronthaul manager 125, which may integrate with RACH detector 130 and/or scheduler 354 and perform operations described herein. In some embodiments, each of host 1202 or network node 1204 may perform a portion of the operations performed by fronthaul manager 125, and the two entities together perform the operations described herein by fronthaul manager 125. For example, network node 1204 may perform the operations relating to reference 502 while host 1202 perform the operations relating to reference 504, or vice versa.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Terms

References in the specification to “one embodiment,” “an embodiment,” “an example embodiment,” and so forth, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The description and claims may use the terms “coupled” and “connected,” along with their derivatives. These terms are not intended as synonyms for each other. “Coupled” is used to indicate that two or more elements, which may or may not be in direct physical or electrical contact with each other, co-operate or interact with each other. “Connected” is used to indicate the establishment of wireless or wireline communication between two or more elements that are coupled with each other. A “set,” as used herein can refer to any whole number of items including one item.

An electronic device stores and transmits (internally and/or with other electronic devices over a network) code (which is composed of software instructions and which is sometimes referred to as a computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical, or other form of propagated signals-such as carrier waves, infrared signals). Thus, an electronic device (e.g., a computer) includes hardware and software, such as a set of one or more processors (e.g., of which a processor is a microprocessor, controller, microcontroller, central processing unit, digital signal processor, application specific integrated circuit (ASIC), field programmable gate array (FPGA), other electronic circuitry, or a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed). When the electronic device is turned on, that part of the code that is to be executed by the processor(s) of the electronic device is typically copied from the slower non-volatile memory into volatile memory (e.g., dynamic random-access memory (DRAM), static random-access memory (SRAM)) of the electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of (1) receiving data from other electronic devices over a wireless connection and/or (2) sending data out to other devices through a wireless connection. This radio circuitry may include transmitter(s), receiver(s), and/or transceiver(s) suitable for radio frequency communication. The radio circuitry may convert digital data into a radio signal having the proper parameters (e.g., frequency, timing, channel, bandwidth, and so forth). The radio signal may then be transmitted through antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate with wire through plugging in a cable to a physical port connected to an NIC. One or more parts of an embodiment of the invention may be implemented using different combinations of software, firmware, and/or hardware.

A network node is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video). Similarly, a control plane device (e.g., the COTS control plane device 904) is also an electronic device.

The terms “module,” “logic,” and “unit” used in the present application, may refer to a circuit for performing the function specified. In some embodiments, the function specified may be performed by a circuit in combination with software such as by software executed by a general-purpose processor.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices, and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

1. A method for allocating fronthaul network resources, the method comprising:
determining that a number of Random Access Channel (RACH) requests received at a first radio frequency (RF) node for a first cell from a plurality of user equipments (UEs) during a time period has reached a threshold, wherein the first cell is included in a plurality of cells served by a fronthaul network, and wherein a first set of resources in the fronthaul network is dedicated to the first cell; and
in response to determining that the number of RACH requests received during the time period reached the threshold, triggering a resource reconfiguration of the fronthaul network to allow a second set of resources dedicated to a second cell included in the plurality of cells to be used to serve the first cell, in addition to the first set of resources.

2. The method of claim 1, wherein the threshold is based on at least one of a number of active UEs served by the first cell, and a minimum period of an average duration of a discontinuous reception (DRX) cycle and a configured downlink paging cycle.

3. The method of claim 1, wherein a volume of the second set of resources to be used to serve the first cell is based on the time period and a maintenance duration for one or more of a RF node, a baseband node, or an intermediate node between the RF node and the baseband node and within the fronthaul network.

4. The method of claim 3, wherein the maintenance duration corresponds to an amount of time expected to perform one or more of rebooting, reconfiguring, or upgrading the following:
at least one of the RF node, the baseband node, the intermediate node within the fronthaul network, or
one or more functions of the RF node, one or more functions of the baseband node, or one or more functions of the intermediate node within the fronthaul network.

5. The method of claim 3, wherein the volume of the second set of resources to be used to serve the first cell is further based on the number of RACH requests received at the first RF node for the first cell over the time period.

6. The method of claim 1, wherein the threshold is based on a first number of RACH requests accumulated over the time period according to uplink data at media access control (MAC) layer of UEs for the first cell.

7. The method of 1, wherein the threshold is based on a second number of RACH requests accumulated over the time period according to UEs for the first cell responding to paging messages in downlink from the RF nodes for the first cell.

8. The method of claim 1, wherein the second set of resources to be used to serve the first cell are proportional to expected traffic demand that was dedicated to the second cell prior to the resource reconfiguration.

9. The method of claim 1, wherein the second set of resources to be used to serve the first cell include link bandwidth in the fronthaul network that was prioritized or guaranteed to the second cell prior to the resource reconfiguration.

10. The method of claim 1, wherein the second set of resources to be used to serve the first cell include one or more timeslots that were prioritized or guaranteed to the second cell prior to the resource reconfiguration.

11. The method of claim 1, wherein triggering the resource reconfiguration comprises sending a resource reconfiguration request to a baseband node, and the baseband node scheduling the resource reconfiguration as requested or as available resources in the fronthaul network.

12. The method of claim 1, wherein the first set of resources and the second set of resources are assigned to serve the RACH requests and subsequent operations for UEs served by the first cell.

13. An electronic device for allocating fronthaul network resources, the electronic device comprising:
a processor and machine-readable storage medium that provides instructions that, when executed by the processor, are capable of causing the processor to perform:
determining that a number of Random Access Channel (RACH) requests received at a first radio frequency (RF) node for a first cell from a plurality of user equipments (UEs) during a time period has reached a threshold, wherein the first cell is included in a plurality of cells served by a fronthaul network, and wherein a first set of resources in the fronthaul network is dedicated to the first cell; and
in response to determining that the number of RACH requests received during the time period reached the threshold, triggering a resource reconfiguration of the fronthaul network to allow a second set of resources dedicated to a second cell included in the plurality of cells to be used to serve the first cell, in addition to the first set of resources.

14. The electronic device of claim 13, wherein the threshold is based on at least one of a number of active UEs served by the first cell, and a minimum period of an average duration of a discontinuous reception (DRX) cycle and a configured downlink paging cycle.

15. The electronic device of claim 13, wherein a volume of the second set of resources to be used to serve the first cell is based on the time period and a maintenance duration for one or more of a RF node, a baseband node, or an intermediate node between the RF node and the baseband node and within the fronthaul network.

16. (canceled)

17. (canceled)

18. The electronic device of claim 13, wherein the threshold is further based on a first number of RACH requests accumulated over the time period according to uplink data at media access control (MAC) layer of UEs for the first cell.

19. The electronic device of claim 13, wherein the threshold is further based on a second number of RACH requests accumulated over the time period according to UEs for the first cell responding to paging messages in downlink from the RF nodes for the first cell.

20. The electronic device of claim 13, wherein the second set of resources to be used to serve the first cell are proportional to expected traffic demand that was dedicated to the second cell prior to the resource reconfiguration.

21. The electronic device of claim 13, wherein the second set of resources to be used to serve the first cell include link bandwidth in the fronthaul network that was prioritized or guaranteed to the second cell prior to the resource reconfiguration.

22. (canceled)

23. (canceled)

24. (canceled)

25. A non-transitory machine-readable storage medium that provides instructions that, when executed by a processor, are capable of causing the processor to perform steps comprising:
determining that a number of Random Access Channel (RACH) requests received at a first radio frequency (RF) node for a first cell from a plurality of user equipments (UEs) during a time period has reached a threshold, wherein the first cell is included in a plurality of cells served by a fronthaul network, and wherein a first set of resources in the fronthaul network is dedicated to the first cell; and
in response to determining that the number of RACH requests received during the time period reached the threshold, triggering a resource reconfiguration of the fronthaul network to allow a second set of resources dedicated to a second cell included in the plurality of cells to be used to serve the first cell, in addition to the first set of resources.
